(19) United States
(12) Patent Application Publication
(10) Pub. No.: US 2024/0054692 A1
(43) Pub. Date: Feb. 15, 2024

(54) DYNAMICALLY ADJUSTED WELL AND POND GRAPHIC INTERFACE METHOD AND SYSTEM

(71) Applicants: Grace Garalde, Davis, CA (US); Ofer Tenenbaum, Napa, CA (US); George Stuart Richmond, Fairfield, CA (US); Jakub Uczciwek, Warsaw (PL)

(72) Inventors: Grace Garalde, Davis, CA (US); Ofer Tenenbaum, Napa, CA (US); George Stuart Richmond, Fairfield, CA (US); Jakub Uczciwek, Warsaw (PL)

(21) Appl. No.: 18/225,082

(22) Filed: Jul. 21, 2023

Related U.S. Application Data
(60) Provisional application No. 63/391,636, filed on Jul. 22, 2022.

(51) Int. Cl. G06T 11/00; G01F 23/80

(52) U.S. Cl. CPC G06T 11/00; G01F 23/802

(57) ABSTRACT

A method of dynamically adjusting a water source graphic interface. The method includes providing a water source containing water at a water level that fluctuates over time and use, and includes a changeable maximum water level, measuring the water level using a water source sensor coupled to the water source to obtain a water level value, and sending the collected water level value to a server. A current maximum water level value is determined and a water source graphic is generated, having a fixed space, from the collected water level value using an application carried by one of the server and the communication device. The fixed space is given a scale determined by the current maximum water level value. The generated water source graphic is displayed on the communication device.

### CROSS-REFERENCE TO RELATED APPLICATION

This application claims the benefit of U.S. Provisional Application No. 63/391,636, filed 22 Jul. 2022.

### FILED OF THE INVENTION

This invention relates to water use management. More particularly, the present invention relates to obtaining and illustrating well information.

### BACKGROUND OF THE INVENTION

Management and maintenance of wells, ponds, reservoirs and the like is often dependent upon accurate and easily understood information. While numbers can accurately convey important well data, graphical illustrations have been found to be more easily and quickly assimilated. The problem with graphical representations is that they are often of a scale that distorts the visual information. Graphic representations of wells employ the depth of the well as the visual scale. Wells can be very deep and yet only contain a small amount of water relative to the total depth of the well. For example, a graphic representation to scale of a 1000-foot-deep well that maintains a water level of between 100-120 ft would appear as though there was very little water in the well. Conversely, a very shallow well with high water level can appear to contain substantial amounts of water when actually very little water is present. Thus, while graphic representation of wells can provide well information in an easily read format, it can also result in distortions and unintended misinformation.

It would be highly advantageous, therefore, to remedy the foregoing and other deficiencies inherent in the prior art.

An object of the present invention is to provide a method and system for providing a dynamically adjusting scale for graphic representations of wells.

### SUMMARY OF THE INVENTION

Briefly to achieve the desired objects and advantages of the instant invention in accordance with a preferred embodiment provided is a method of dynamically adjusting a water source graphic interface. The method includes the steps of providing a water source containing water at a water level that fluctuates over time and use, and includes a changeable maximum water level, measuring the water level of the water source using a water source sensor coupled to the water source to obtain a water level value, and sending the collected water level value to a server. A current maximum water level value of the water source is determined and a water source graphic is generated, having a fixed space, from the collected water level value using an application carried by one of the server and the communication device. The fixed space is given a scale determined by the current maximum water level value. The generated water source graphic is displayed on the communication device.

In a further aspect of the method of dynamically adjusting a water source graphic interface, the water level value is collected using a water source sensor mote coupled to the water source sensor. The collected water level value is sent from the water source sensor mote to a wirelessly coupled server using a communication protocol. A new water level of the water source is measured using the water source sensor coupled to the water source to obtain a new water level value. The new water level value is collected using the water source sensor mote coupled to the water source sensor. The collected new water level value is sent from the water source sensor mote to the wirelessly coupled server using the communication protocol. The new water level value is compared to the current maximum water level value. The current maximum water level value is updated to a new maximum water level value with the new water level value if the new water level value is greater than the current maximum water level value. The fixed space is given a new scale determined by the new maximum water level value.

Also provided, is a dynamically adjusted water source graphic interface including a water source containing water at a water level that fluctuates over time and use, and includes a changeable maximum water level. A water source sensor is coupled to the water source for periodic measuring of the water level to collect water level data including the changeable maximum water level. A server is coupled to the water source sensor. A communication device is coupled to the server. An application is carried by one of the server and the communication device to generate a water source graphic interface for display on the communication device. The water source graphic interface includes a fixed space displayed on the communication device having a scale determined by the changeable maximum water level. A graphic representation of the water source including a current water level, as measured by the water source sensor, is displayed in the fixed space in relation to the changeable maximum water level.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a simplified schematic diagram of a water extraction system for pumping water from a well to a storage tank, according to the present invention;

FIG. 2 is a simplified schematic diagram of a sensing and control system of the water extraction system according to the present invention;

FIG. 3 is an illustration of the dynamic graphic interface displayed on the communication device;

FIG. 4 is a simplified flow chart of the adjustment to scale of the dynamic graphic interface;

FIG. 5A-D illustrate examples of the adjusted scale of the dynamic graphic interface for a well,

FIG. 6 illustrates the flow process of dynamically adjusting the well graphic interface;

FIG. 7 is an illustration of the dynamic graphic interface displayed on the communication device for a pond; and

FIG. 8 is an illustration of another dynamic graphic interface displayed on the communication device.

### DETAILED DESCRIPTION

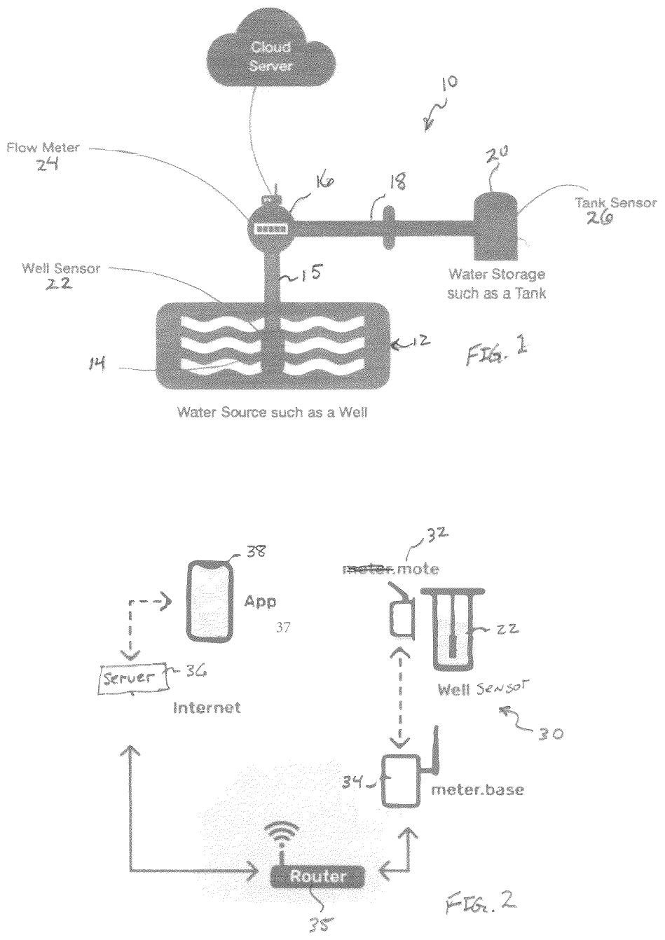

Turning now to the drawings in which like reference characters indicate corresponding elements throughout the several views, attention is directed to FIG. 1 which illustrates a water extraction system generally designated 10. Water extraction system 10 is preferably used with a well 12, but can be used for other water sources such as ponds, reservoirs and the like. It will be understood by one skilled in the art that while a well is preferred, the invention described can be used with substantially any renewable water source such as a well, pond, reservoir or the like, which can be lowered by extraction of water and which is renewed by natural inflow of water such as by aquifers, streams, rain and the like. In the preferred embodiment, well 12 is substantially any type of well typically fed by a water source such as an aquifer. While not always the case, well 12 conventionally includes a well casing extending from the ground surface to some point below the water level. The casing is a tubular structure that is placed in the drilled well to maintain the well opening. The casing keeps possibly contaminated surficial water from reaching the aquifer zone underground and prevents contaminants from mixing with the water. The casing also holds back unstable earth materials so that they do not collapse into well 12. System 10 of the present invention includes a pump 14 positioned proximate the bottom of well 12, below the waterline, and connected to a standing pipe 15 extending upwardly to a well head 16. From well head 16 a distribution line 18 directs pumped water to a storage tank 20. Thus, pump 14 pumps water collected in well 12 to storage tank 20 through standing pipe 15 and distribution line 18.

Still referring to FIG. 1, system 10 further includes a well sensor 22 to measure the water level in well 12 or in other water sources as described. Well sensor 22 measures the water level in well 12 and is preferably a barometric sensor positioned above pump 14 at the base of well 12 but can be an ultrasonic sensor positioned at the top or other sensor or device measuring the water level. The barometric sensor measures the hydrostatic pressure above the sensor and uses this to calculate the total liquid depth in well 12. While not necessary for this specific application, a flow meter 24 is carried at well head 16 or anywhere along standing pipe 15 or distribution pipe 18, and measures the rate of water flow from well 12. A tank sensor 26 measures the water level in tank 20 (can be a barometric sensor carried at the base of tank 20, an ultrasonic sensor positioned at the top of tank 20 or other sensor or device measuring the water level).

With additional reference to FIG. 2, a sensing and control system generally designated 30 of water extraction system 10 is illustrated. Sensing and control system 30 includes a mote 32 coupled to well sensor 22. While other reporting devices can be used, a mote is a small, low-cost, low-power computer which monitors one or more sensors. The mote connects to the outside world with a radio link. In the present invention, mote 32 sends uplinks, with data collected by well sensor 22, via LoRaWAN (915 MHz in US) to a gateway 34 that is then internet connected through a router 35, reporting to a server 36 and then to an application, which serves as an interface for management of the system, carried by a communication device 38 such as a smart phone and the like. LoRa and LoRaWAN together define a low power, wide area (LPWA) networking protocol designed to wirelessly connect battery operated “things” to the internet in regional, national and global networks, and targets key internet of things (IoT) requirements such as bi-directional communication, end-to-end security, mobility and localization services. In the US LoRWAN uses 902-928 Mhz frequency. While the previous is preferred, it is simply one example of a communication protocol. It will be understood that other communication protocols can be used such as traditional IP networks or other long range low power networks. As another example, TCP/IP protocol can be used. It will also be understood that while a downloadable application 37 can be carried by communication device 38 such as a smartphone which receives data from server 36, application 37 can be supplied by server 36 as Software as a Service (SaaS) which allows users to connect to and use cloud-based apps over the Internet. SaaS provides a software solution that is purchased on a pay-as-you-go basis from a cloud service provider. The use of an app is essentially rented such as by a subscription model, and the users connect to it over the Internet, usually with a web browser. It will be understood that the use of the app can also be provided in other ways, such as it may be offered free of charge or the whole financial model will revolve on saving water and minting of tokens. All of the underlying infrastructure, middleware, app software, and app data are located in the service provider's data center.

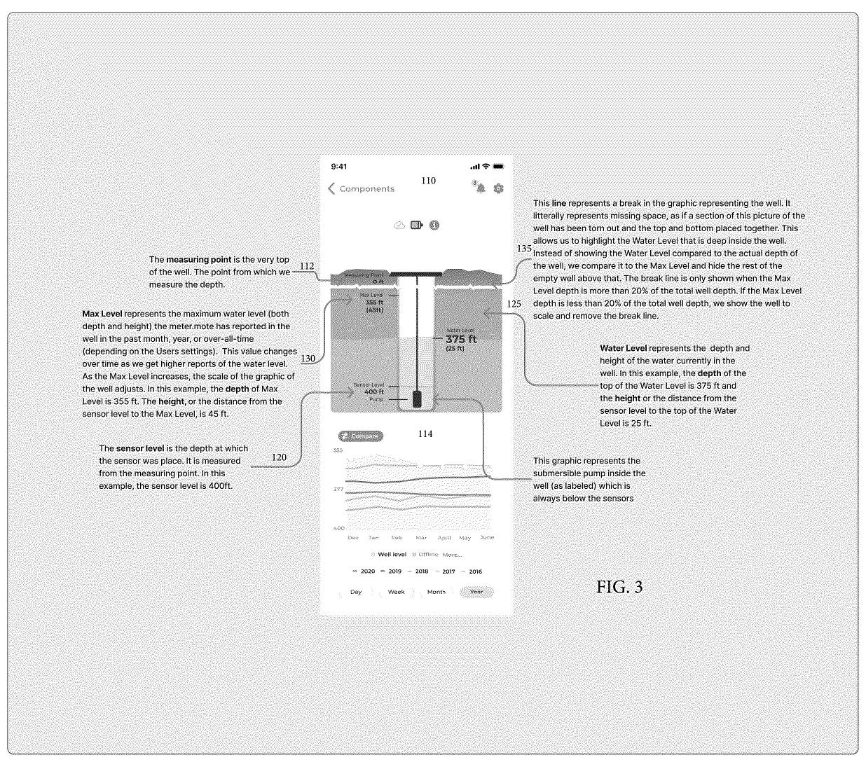

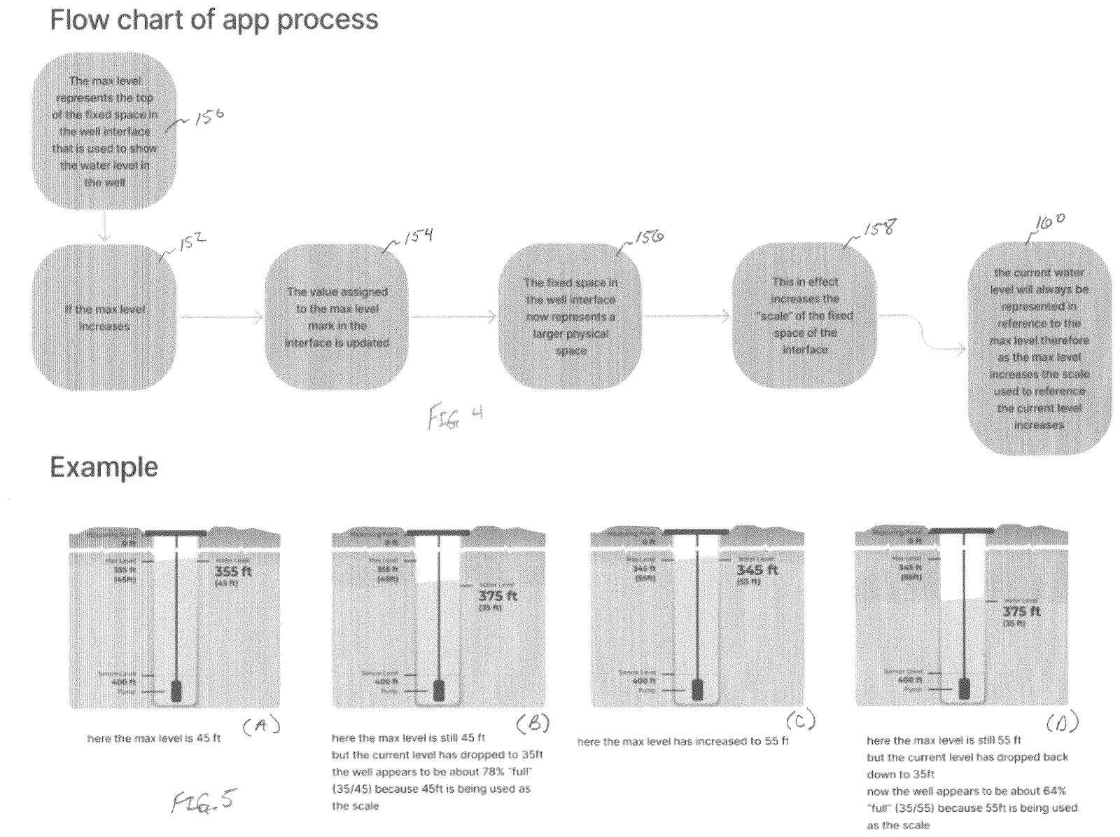

Turning now to FIG. 3, illustrated is a dynamic well graphic interface, generally designated 110. Well graphic 110 is displayed by application 37 on communication device 38 to give the user visual as well as numerical information on the condition of the well. The specific information given is the depth of well 12, the depth of the sensor in the well, the depth of the top of the water column therein, and the height of the water column. The graphic displayed by communication device 38 is dynamically adjusted dependent on a measured maximum water column height as periodically determined by sensor 22 and sent to server 36 by mote 32.

This well information is determined using a measuring point 112 at the very top of well 12, such as at well head 16, and a sensor level 120. Sensor level 120 is the depth within well 12 at which sensor 22 has been placed, just above pump 14 at the bottom of well 12. Depth of well 12 is measured from measuring point 112 to sensor level 120. In this example, the sensor level is 400 feet from measuring point 112, making well 12 400 feet deep. The graphic represents the submersible pump 14 inside well 12 and always below sensor level 120. This graphic primarily focusses on the depth of the well and water therein as measured from measuring point 112, with the numbers being the depth from measuring point 112. However, it will be understood that the graphic can also show or alternatively show the level of the various desired points. The numbers representing the level values are measured from the sensor level 120. The graphic representation remains the same in each, only the numbers for the values change from the different perspectives.

A water level 125 represents the depth of and the height of the water column currently in the well. As in the example of FIG. 3, the depth of the top of the water column is 375 feet below measuring point 112 and the height (level) of the water column, from the top surface thereof to sensor level 120, is 25 feet. A max level 130 represents the maximum water level (both depth and height) the mote has reported in well 12 at specific intervals over a period of time. The period of time can be selected by the user and includes last month, last year, and all time since measurements have been recorded. This value can change over time if higher water levels are detected. If max level 130 increases, the scale of the graphic of well 12 adjusts. In this example, the depth of max level 130 is 355 feet. The height (level) of the water column (measured from sensor level 120) is 45 feet.

Max level 130 will only adjust if a new reading is greater than the previous max level, but current water level 125 will always adjust based on the current reading. E.g. wells can be very deep and yet only contain a small amount of water relative to the total depth of the well. For example, if a 1000 foot well that maintains a water level of between 100-120 ft, is represented to scale it would appear as though there was very little water in the well. Instead of using the depth of the well as the visual scale, a max water level is collected over time and used to provide the scale.

A break line 135 represents a break in the graphic representation of well 12 and represents missing space. Break line 135 represents a section of well 12 that has been removed, and the top and the bottom placed adjacent to one another. This highlights the water level that is deeper in the well. Instead of showing the water level compared to the actual depth of the well, it is compared to max level 130 and the rest of the well above that is hidden. The break line is only used when the max level depth is more than 20% of the total well depth. If the max level depth is less than 20% of the total well depth, the well is shown to scale without the break line. While 20% is used in the preferred embodiment, other values can be employed, such as 25% and the like, depending upon the effect desired.

Referring now to FIG. 4, the process of changing the dynamic well graphic interface is illustrated. The graphic of the well includes a fixed space displayed on communication device 38. The fixed space is used to show the water and well. That fixed space shows current water level 125 in relation to max level 130 (150). When a new max level is detected (152), a value is assigned to the max level 130. The value assigned to max level 130 changes the scale of the fixed space and changes the image of the water level in the well. Max level 130 represents the top of the fixed space in the well graphic interface used to show the water conditions in the well. When the water level in the well increases the value assigned to the max level is updated (154). The fixed space in the well graphic interface now represents larger space (156). The change in value for the max level increases the scale of the fixed space (158). The current water level 125 is always represented in reference to max level 130, therefore, as the max level increases, the scale used to reference the current level increases (160).

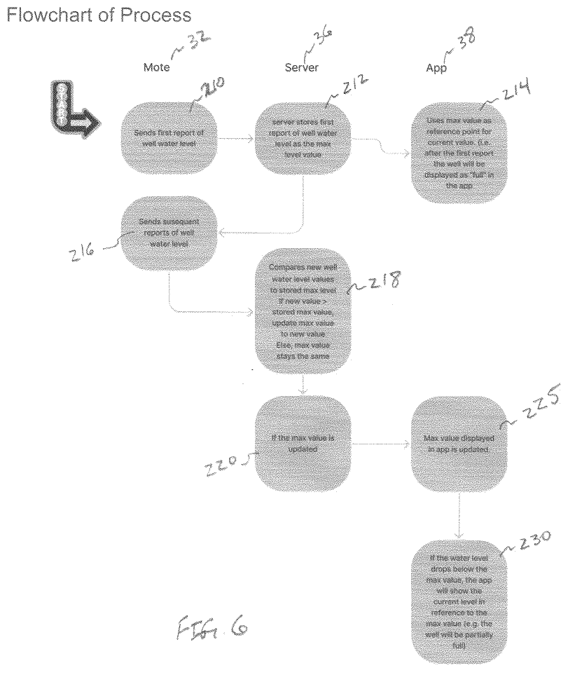

Turning now to FIGS. 5A-5D, 5A is an example of a well graphic interface with max level 130 at a depth of 355 feet. Sensor level 120 is 400 feet so at max level 130 there is a water height of 45 feet. FIG. 5B is an example of a well graphic interface with max level 130 remaining at 355 feet or 45 feet in height from sensor level 120, but the current water level 125 has dropped to 35 feet in height. The well in the graphic looks to be about 78% full (35/45) because 45 feet is being used to determine the scale. In FIG. 5C, an example of the well graphic interface shows max level 130 at a depth of 355 feet, thus, the height of max level 30 has increased to 55 feet from sensor level 120. The current water level 125 is at 55 feet, which is the max level 130. In FIG. 5D, an example of the well graphic interface shows max level 130 remaining at a depth of 355 feet or 55 feet from sensor level 120, but current water level 125 has dropped to 35 feet from sensor level 120 or a depth of 375 feet. The well in the graphic looks to be about 64% full (35/55) because 55 feet is being used to determine the scale. While the fixed space remains unchanged, the scale of the well represented within the space has changed due to the change of max level 130.

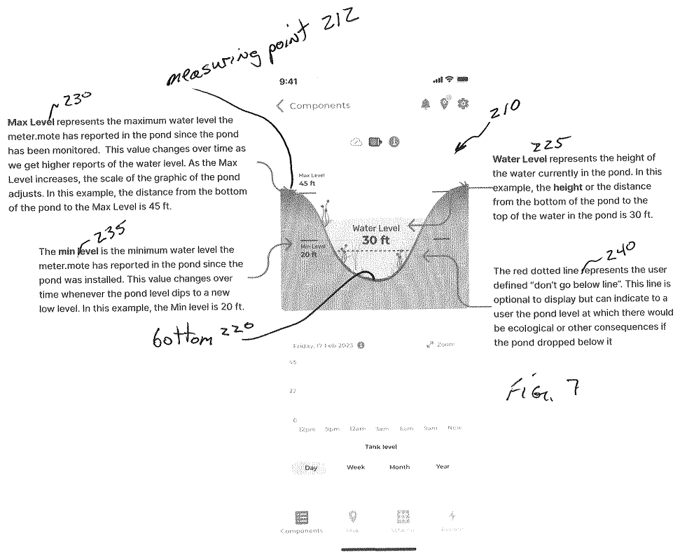

The process of dynamically adjusting the well graphic interface is illustrated in FIG. 6. When the system is set up, mote 32 sends a first report 210 of the well water level to server 36. Server 36 stores the first report of the well water level as the max level value 212. The first report is received by application 38 which then uses this max level value as the reference point for the current value. After the first report, the well graphic interface will show the well as full. Mote 32 then sends subsequent reports 216 of well water level to server 36 at desired intervals. Upon receiving the subsequent reports of the well water level, server 36 compares 218 the new well water level value to the stored max level value. If the new well water level value is greater than the stored max level value, the max level value is updated to the new water level value. If the water level value is less than the stored max level value, the max level value remains unchanged. If the max level value has been updated 220 to the new water level value, the max level value displayed in the application 38 is updated 225. If the water level drops below the max value, the application 38 will show 230 the current level in reference to the max level. Thus, the well graphic will show partially full.

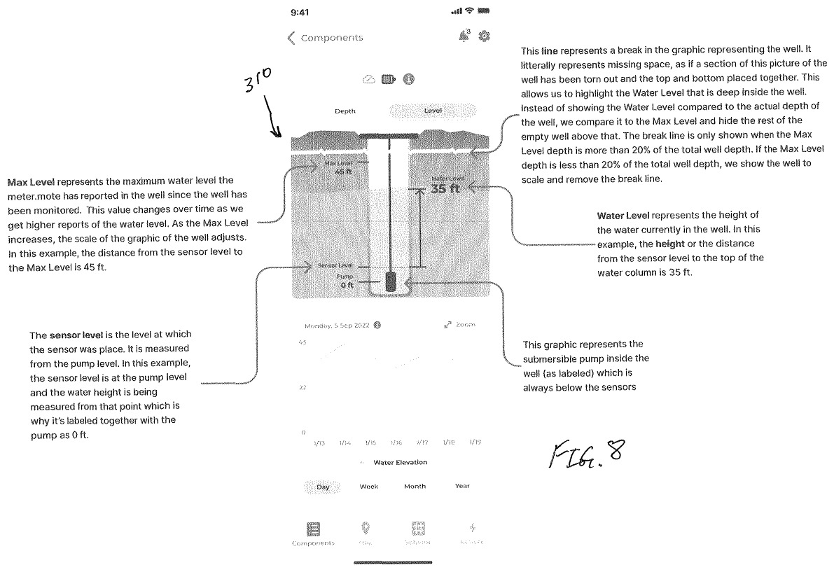

Referring now to FIG. 7, a dynamic graphic for a water source other than a well is illustrated. Specifically, in this embodiment, illustrated is a dynamic pond graphic interface, generally designated 210. Pond graphic 210 is displayed by application 37 on communication device 38 to give the user visual as well as numerical information on the condition of a pond. The pond being monitored would have the same elements as well 12. The specific information given is the depth of a pond (from the bottom thereof), the height of the water in the pond or the distance from the bottom to the surface of the water in the pond. The graphic displayed by communication device 38 is dynamically adjusted dependent on a measured maximum water depth as periodically determined by sensor 22 and sent to server 36 by mote 32.

This pond information is determined using a sensor level or bottom 220 which is the depth of the pond at which sensor 22 has been placed at the bottom of the pond. Depth of the pond is measured from a measuring point 212 to sensor level or bottom 220. In this example, the bottom is 45 feet from measuring point 112, making the pond 45 feet deep. A water level 225 represents the height of the water currently in the pond, with the example beings 30 feet. The height is the distance from the bottom 220 of the pond to the top of the water. A max level 230 represents the maximum water level the mote has reported in the pond at specific intervals over a period of time. The period of time can be selected by the user and includes days, months, years, and all time since measurements have been recorded. This value can change over time if higher water levels are detected. If max level 230 increases, the scale of the graphic of the pond adjusts. In this example, the height of max level 230 is 45 feet. A minimum level 235 is the minimum water level mote 32 has reported in the pond since the first measurement was taken. This value changes over time whenever the pond level dips to a new low level. In this example, the minimum level is 20 feet. Max level 230 will only adjust if a new reading is greater than the previous max level, but current water level 225 will always adjust based on the current reading. Instead of using the depth of the pond as the visual scale, a max water level is collected over time and used to provide the scale. A stop level 240 can also be used. Stop level 240 is indicated by a red dotted line. The stop level is used to indicate to the user the pond level at which there would be ecological or other consequences if the pond dips below it.

Turning now to FIG. 8, illustrated is another embodiment of a dynamic well graphic interface, generally designated 310. Well graphic 310 is displayed by application 37 on communication device 38 to give the user visual as well as numerical information on the condition of the well. Dynamic well graphic interface 210 is essentially the same as dynamic well graphic interface 110 with the numerical information from a different perspective. Specifically, the various numerical values for data points in dynamic well graphic interface 110 are measured from measuring point 112. This gives a depth of each of the data points. The various numerical values for data points in dynamic well graphic interface 310 are measured from sensor level 120. This gives a height (level) of each of the data points. These points are each the same, just having numerical values from a different perspective. The specific information given is the sensor in the well, the height (level) of the top of the water column therein and the maximum water level. The graphic displayed by communication device 38 is dynamically adjusted in either instance dependent on a measured maximum water column height or depth as periodically determined by sensor 22 and sent to server 36 by mote 32. Application 37 can be used to toggle between dynamic well graphic interface 110 and dynamic well graphic interface 310 depending upon which the user is most comfortable with.

The present invention is described above with reference to illustrative embodiments. Those skilled in the art will recognize that changes and modifications may be made in the described embodiments without departing from the nature and scope of the present invention. Various changes and modifications to the embodiments herein chosen for purposes of illustration will readily occur to those skilled in the art. To the extent that such modifications and variations do not depart from the spirit of the invention, they are intended to be included within the scope thereof.

1. A method of dynamically adjusting a water source graphic interface comprising the steps of:
providing a water source containing water at a water level that fluctuates over time and use, and includes a changeable maximum water level;
measuring the water level of the water source using a water source sensor coupled to the water source to obtain a water level value;
sending the collected water level value to a server;
determining a current maximum water level value of the water source and generating a water source graphic, having a fixed space, from the collected water level value using an application carried by one of the server and the communication device;
giving the fixed space a scale determined by the current maximum water level value; and
displaying the generated water source graphic on the communication device.

2. The method of dynamically adjusting a water source graphic interface as claimed in claim 1 wherein the step of giving the fixed space a scale determined by the current maximum water level value includes the water level appearing as full in the water source graphic with the scale.

3. The method of dynamically adjusting a water source graphic interface as claimed in claim 1 further comprising the steps of:
measuring a subsequent water level of the water source using the water source sensor coupled to the water source to obtain a new water level value;
sending the collected new water level value to the server;
comparing the new water level value to the current maximum water level value;
updating the current maximum water level value to a new maximum water level value with the new water level value if the new water level value is greater than the current maximum water level value; and
giving the fixed space a new scale determined by the new maximum water level value.

4. The method of dynamically adjusting a water source graphic interface as claimed in claim 3 wherein the step of giving the fixed space a new scale determined by the new maximum water level value includes the water level appearing as full in the water source graphic with the new scale.

5. The method of dynamically adjusting a water source graphic interface as claimed in claim 1 further comprising the steps of:
measuring a subsequent water level of the water source using the water source sensor coupled to the water source to obtain a new water level value;
sending the collected new water level value to the server;
comparing the new water level value to the current maximum water level value; and
displaying a partially full water source graphic if the new water level value is less than the current maximum water level value in the scale of the fixed space.

6. The method of dynamically adjusting a water source graphic interface as claimed in claim 1 wherein the step of sending the collected water level value to a server further comprising the steps of:
collecting the water level value using a water source sensor mote coupled to the water source sensor; and
sending the collected water level value from the water source sensor mote to a wirelessly coupled server using a communication protocol.

7. A method of dynamically adjusting a water source graphic interface comprising the steps of:
providing a water source containing water at a water level that fluctuates over time and use, and includes a changeable maximum water level;
measuring the water level of the water source using a water source sensor coupled to the water source to obtain a water level value;
collecting the water level value using a water source sensor mote coupled to the water source sensor;
sending the collected water level value from the water source sensor mote to a wirelessly coupled server using a communication protocol;
determining a current maximum water level of the water source;
generating a water source graphic, having a fixed space, from the collected water level data using an application carried by one of the server and the communication device;
giving the fixed space a scale determined by the current maximum water level;
displaying the generated water source graphic on the communication device;
measuring a new water level of the water source using the water source sensor coupled to the water source to obtain a new water level value;
collecting the new water level value using the water source sensor mote coupled to the water source sensor;
sending the collected new water level value from the water source sensor mote to the wirelessly coupled server using the communication protocol;
comparing the new water level value to the current maximum water level value;
updating the current maximum water level value to a new maximum water level value with the new water level value if the new water level value is greater than the current maximum water level value; and
giving the fixed space a new scale determined by the new maximum water level value.

8. The method of dynamically adjusting a water source graphic interface as claimed in claim 7 wherein the step of giving the fixed space a scale determined by the current maximum water level value includes the water level appearing as full in the water source graphic with the scale.

9. The method of dynamically adjusting a water source graphic interface as claimed in claim 8 wherein the step of giving the fixed space a new scale determined by the new maximum water level value includes the water level appearing as full in the water source graphic with the new scale.

10. The method of dynamically adjusting a water source graphic interface as claimed in claim 7 wherein the step of updating the current maximum water level value to a new maximum water level value with the new water level value if the new water level value is greater than the current maximum water level value, further comprising the steps of:
leaving the current maximum water level value and the scope of the fixed space unchanged if the new water level value is less than the current maximum water level value; and
displaying a partially full water source graphic in the scale of the fixed space.

11. The method of dynamically adjusting a water source graphic interface as claimed in claim 7 further comprising the steps of:
measuring a subsequent water level of the water source using the water source sensor coupled to the water source to obtain a subsequent water level value;
collecting the subsequent water level value using the water source sensor mote coupled to the water source sensor;
sending the collected subsequent water level value from the water source sensor mote to the wirelessly coupled server using the communication protocol;
comparing the subsequent water level value to the new maximum water level value; and
displaying a partially full water source graphic in the new scale of the fixed space if the subsequent water level value is less than the new maximum water level value.

12. A dynamically adjusted water source graphic interface comprising:
a water source containing water at a water level that fluctuates over time and use, and includes a changeable maximum water level;
a water source sensor coupled to the water source for periodic measuring of the water level to collect water level data including the changeable maximum water level;
server coupled to the water source sensor;
a communication device coupled to the server;
an application carried by one of the server and the communication device to generate a water source graphic interface for display on the communication device;
the water source graphic interface including:
a fixed space displayed on the communication device having a scale determined by the changeable maximum water level; and
a graphic representation of the water source including a current water level, as measured by the water source sensor, displayed in the fixed space in relation to the changeable maximum water level.

13. The dynamically adjusted water source graphic interface as claimed in claim 12 further comprising:
a new changeable maximum water level higher than the changeable maximum water level; and
the fixed space displayed on the communication device having a new scale determined by the new changeable maximum water level.

14. The dynamically adjusted water source graphic interface as claimed in claim 12 wherein the water source is a well or a pond.

15. The dynamically adjusted water source graphic interface as claimed in claim 12 further including a water source sensor mote wirelessly coupled, using a communication protocol, between the water level sensor and the server for uploading collected water level data to the server.
